(19) United States
(12) Patent Application Publication
(10) Pub. No.: US 2003/0219180 A1
(43) Pub. Date: Nov. 27, 2003

(54) Oil-impregnated bearing

(76) Inventor: Hui-Wen Huang, Taipei (TW)

Correspondence Address: BIRCH STEWART KOLASCH & BIRCH, PO BOX 747, FALLS CHURCH, VA, 22040-0747, US

(21) Appl. No.: 10/152,042

(22) Filed: May 22, 2002

(51) Int. Cl. F16C 33/02

(52) U.S. Cl. 384/279

(57) ABSTRACT

An oil-impregnated bearing for providing stable rotational performance for a shaft to carry a greater work load and reduce friction force between the shaft and the bearing. The invention includes extended troughs formed on the peripheral surface of a center opening of the oil-impregnated bearing to alter the shape of the center opening to become a geometric polygon such that the contact area between the center opening and the shaft may be reduced, thereby decreasing friction and operation noise. The extended troughs may contain a solid state lubrication agent to prevent the temperature of the bearing from rising during operation.

### FIELD OF THE INVENTION

The invention relates to an oil-impregnated bearing adopted for use on shafts of electric motors and particularly to an oil-impregnated bearing that has additional extended troughs to alter the shape of the center opening of the bearing to increase its service life and operational performance.

### BACKGROUND OF THE INVENTION

Bearings are auxiliary rotational elements to support shafts of electric motors. They are essential elements for motors. Most motors cannot function properly if the bearings are missing. Commonly used bearings are ball bearings. A ball bearing mainly consists of an outer bearing sleeve and an inner bushing with a plurality of rolling balls located therebetween. The inner bushing is tightly coupled with a shaft to rotate relative to the outer bearing sleeve. The rolling balls are covered by a solid state lubrication agent such as grease to increase lubrication properties of the ball bearing.

Ball bearings are generally manufactured with high precision. However, when running at high temperature for a long period of time, properties of the lubrication agent tend to deteriorate and the lubrication agent covering the rolling balls also tends to be consumed. All this could result in greater noise when the bearings are operating. In addition, the ball bearings are high cost items. They are not economically justified for applications that require a great number of bearings, such as DC brushless fans, optical disk drives, DVD-ROM devices, or the like. In those environments oil-impregnated bearings or sleeve bearings are usually used to substitute ball bearings. Oil-impregnated bearings generally are priced about one eighteenth of ball bearings. Oil-impregnated bearings generally can be grouped into self-lubrication bearings and oil-less bearings. They are mainly made from materials such as iron, copper, iron-copper alloy, stainless steel, and the like, and are fabricated by continuous sintering at high temperature (about 760 to 1200 degrees Celsius). Then they are vacuated to withdraw air from capillary cavities formed therein, and lube oil is injected into the capillary cavities. In general, oil content ranges from 18% to 25% depending on sintering structure and density.

Referring to FIGS. 1A and 1B, when an oil-impregnated bearing is used, a shaft is inserted into a round opening 31 formed in the center of the oil-impregnated bearing 30. The shaft and the oil-impregnated bearing 30 maintain a clearance between them (as opposed to the tight coupling of the ball bearing). When they are rotated relative to each other, lube oil in the bearing 30 is spread between the two to provide lubrication Although oil-impregnated bearings are less expensive, when operating at high speeds, the lube oil contained therein tends to evaporate and become sticky, resulting in a worse lubrication. Moreover, such an ill lubrication will bring about much more noise and the durability of the oil-impregnated bearing 30 suffers.

### SUMMARY OF THE INVENTION

The primary object of the invention is to resolve the foregoing disadvantages. The invention provides an oil-impregnated bearing that has an altered center opening to reduce the contact area between the bearing and the shaft thereby to greatly increase bearing performance and service life.

The oil-impregnated bearing according to the invention has a center opening and has at least one additional extended trough formed on the peripheral surface of the center opening. The extended trough is formed in the axial direction of the bearing and runs through two lateral sides of the bearing. Thus the shape of the center opening is altered, the contact area between the shaft and the bearing is reduced, and friction force incurred on the contact area also decreases. As a result, temperature does not increase too much even if the bearing runs at high speeds or operates for a long period of time. In addition, lubrication oil properties can be kept relatively stable without deteriorating or evaporating. Therefore the durability of the bearing can be increased while noise generation decreases. In order to further improve the performance of the bearing, the extended troughs may be filled with a solid state lubrication agent (such as grease). In terms of manufacturing, the extended troughs may be formed easily on the periphery of the existing center opening without adding much cost. The bearing thus made can enhance lubrication effects, increase durability, and keep temperature stable. Therefore performance and service life of the oil-impregnated bearing can be greatly improved.

The foregoing, as well as additional objects, features and advantages of the invention will be more readily apparent from the following detailed description, which proceeds with reference to the accompanying drawings. The drawings are only to serve for reference and illustrative purposes, and are not intended to limit the scope of the invention.

### BRIEF DESCRIPTION OF THE DRAWINGS

FIGS. 1A and 1B are schematic views of a conventional oil-impregnated bearing.

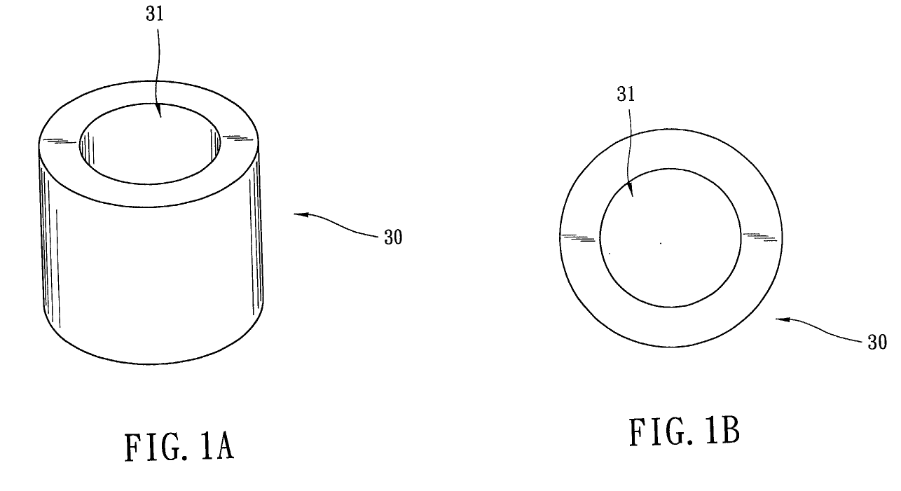

FIGS. 2A and 2B are schematic views of a first embodiment of the invention.

FIGS. 3A and 3B are schematic views of the invention, showing an adjusted contact area.

FIG. 4 is a schematic view of a second embodiment of the invention.

FIGS. 5A and 5B are schematic views of a third embodiment of the invention.

FIG. 6 is a schematic view of yet another embodiment of the invention.

### DESCRIPTION OF THE PREFERRED EMBODIMENTS

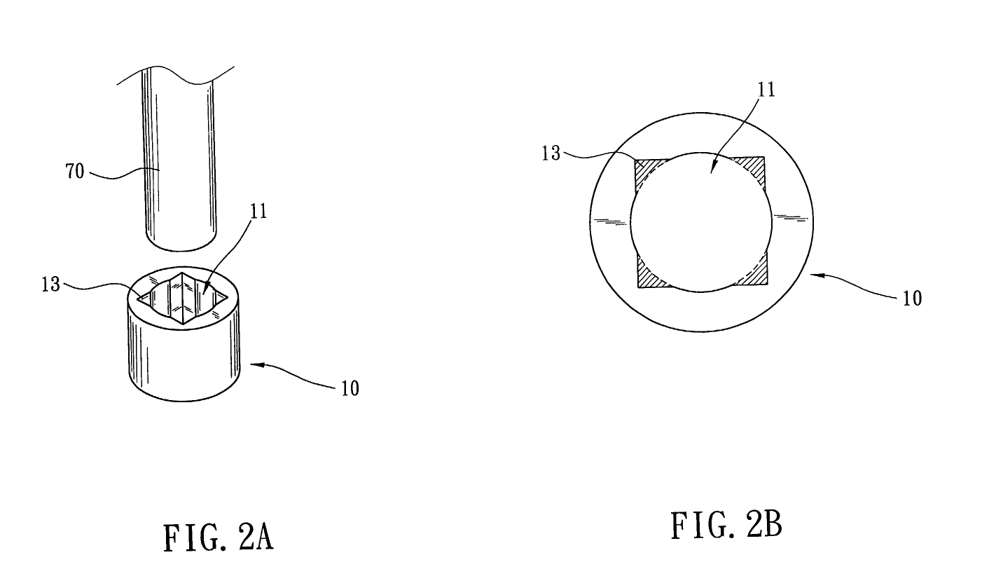

Referring to FIGS. 2A and 2B, the oil-impregnated bearing 10 according to the invention includes a center opening 11 for coupling with a shaft 70. It employs the capillary principle to store selected lube oil. On the periphery of the center opening 11, a plurality of extended troughs 13 are formed in the axial direction of the oil-impregnated bearing 10 and run through two sides of the bearing 10, namely in the longitudinal direction (as shown in FIG. 2A). Hence after the shaft 70 is mounted in the bearing, contact area between the shaft 70 and the bearing 10 decreases greatly. In other words, the areas where the extended troughs 13 are located do not contact the shaft. In terms of manufacturing, the extended troughs 13 may be formed by machining on the periphery of the center opening 11 with minimal additional cost.

As the contact area between the shaft 70 and the inner wall of the center opening 11 is reduced, friction between the two decreases proportionally. When the shaft 70 rotates, the extended troughs 13 can help to lower the temperature of the oil-impregnated bearing 10 under the same operating conditions. Structurally, the extended troughs 13 also can contain more lube oil and form a circulative oil route for protecting the lubrication system. As a result, noise generation decreases. The ability to maintain a lower temperature also enables the bearing to operate for a longer period of time without being damaged, thus greatly improving the service life of the oil-impregnated bearing 10.

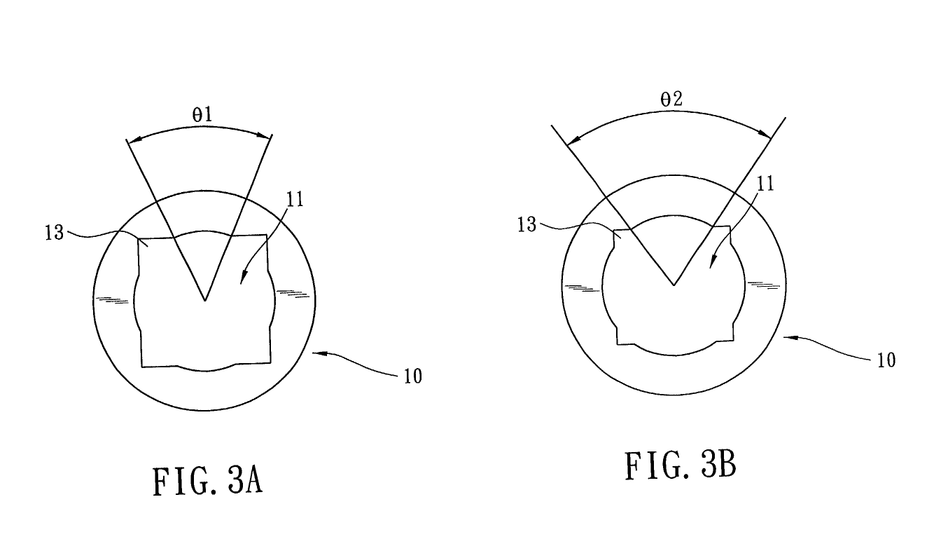

For manufacturing, the oil-impregnated bearing 10 with a substantially square opening may be directly formed by a sintering process, or be made and processed by machining to form the extended troughs 13 (as shown by the diagonal lines in the drawings). Hence cost increase can be minimized. Refer to FIGS. 3A and 3B for a first embodiment of the ratio of the contact area. After the extended troughs 13 are formed, the center opening (including the extended troughs 13 and the center opening 11) is substantially in a rectangular shape. The actual contact area between the shaft 13 and the bearing is an arched portion between the extended troughs 13. For instance, assuming the extended troughs 13 are symmetrical to the center of the center opening 11, the contact area between the shaft 70 and the center opening 11 is θ1/90. If θ1 is 45 degrees, so the contact area is only one half of the original value. By the same token, when the included angle is increased to θ2, the contact area is increased to θ2/90. If θ2 is 60 degrees, the resulting contact area is only ⅔ of the original contact area. Based on the results of precise calculations and experiments, the preferably contact area after reduction is 65% of the original contact area. The proportion of the reduced contact area is equivalent to reduced frictional force during operation, and is also proportional to the increased service life span.

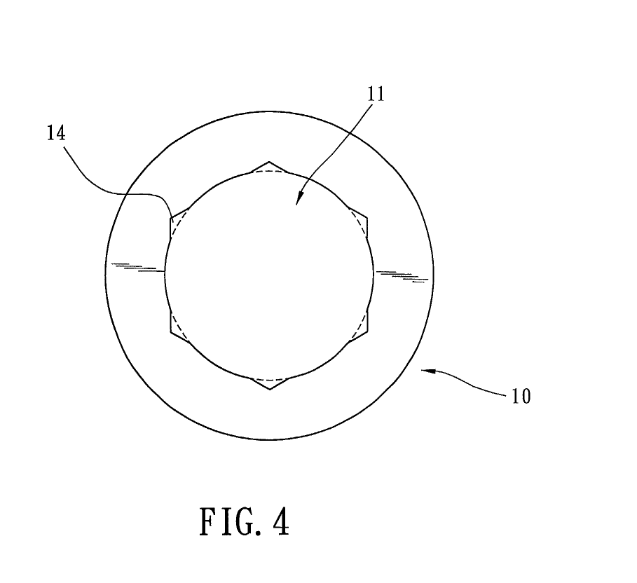

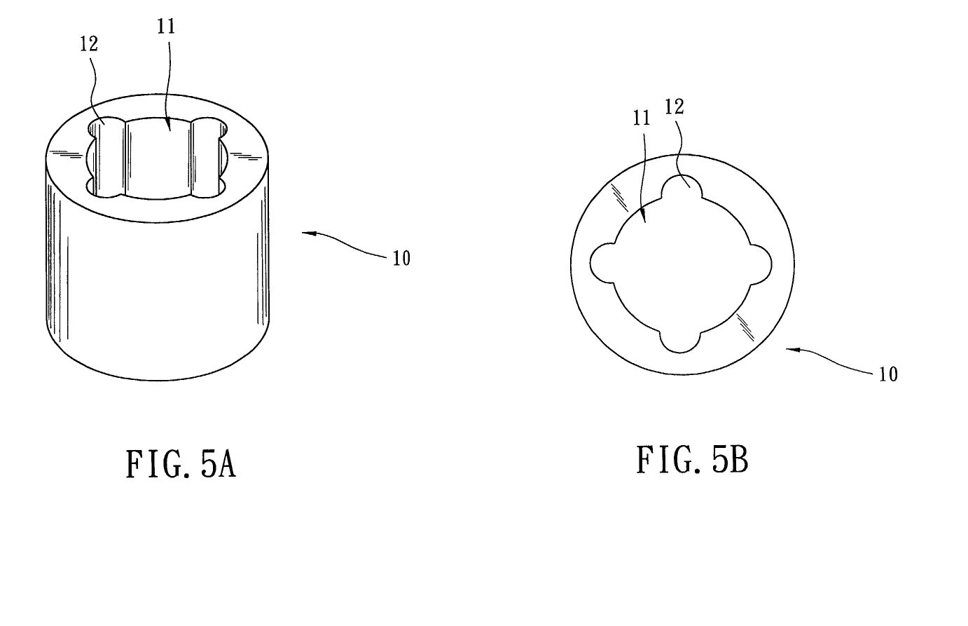

Based on similar principles and architecture set forth above, six extended troughs 14 may also be formed in a hexagonal fashion symmetrical to the center of the center opening 11, as shown in FIG. 4. Of course, other polygonal shapes may also be adopted to accomplish the same effect of reducing the contact area. Adopting this symmetrical design can balance the frictional force when the shaft 70 rotates and dissipates heat evenly. On the other hand, the extended troughs 12 may also be formed in curved types as shown in FIGS. 5A and 5B. Such a design can also effectively reduce the contact area. The number of the curved troughs is selected depending on requirements.

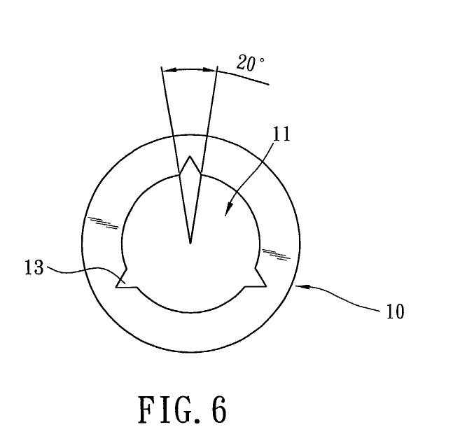

The extended troughs 12 (13, or 14) also can contain a solid state lube agent such as the grease filled in ball bearings. By so doing, the effect of lubrication can be enhanced without adding substantial cost, and service life span can be improved about 30%. As the solid state lube agent has different properties from the lube oil contained in the oil-impregnated bearing, it will not become depleted easily nor evaporate quickly, and can effectively sustain the lubricative function. When adopted for high speed rotation, in order to prevent the solid state lube agent from being thrown out from the extended troughs 12 (13 or 14), a cap may be deployed to cover each side of the oil-impregnated bearing 10. FIG. 6 shows yet another embodiment of the invention that has a triangle shape with each included angle of 20 degrees. The contact area covers 300 degrees, and is about ⅚ of the original contact area. Thus the frictional force may be reduced about 20%, and the contained solid state lube agent can be increased 20%.

By means of the construction set forth above, the oil-impregnated bearing of the invention has at least one additional extended trough formed on the periphery of the center opening of the bearing in the axial direction. The shape of the center opening is altered, and the contact area between the shaft and the center opening is greatly reduced. Frictional force and frictional heat being generated also decrease. Oil contained in the oil-impregnated bearing can be maintained with less deterioration or evaporation. Friction loss can also be reduced. The extended troughs can contain a solid state lube agent to keep the bearing at a relatively low temperature even if operating for a long period of time to thereby further enhance lubrication and service life span of the bearing. In addition, the invention can be adopted easily without substantially increasing manufacturing costs, and can greatly improve the performance and competitiveness of the oil-impregnated bearing.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. An oil-impregnated bearing, comprising:
a center opening for coupling with a shaft; and
at least one extended trough communicating with the center opening for reducing contact area between the shaft and the inner wall surface of the center opening.

2. The oil-impregnated bearing of claim 1, wherein the extended trough is formed in the axial direction of the bearing and runs through two sides of the bearing.

3. The oil-impregnated bearing of claim 1, wherein the extended trough contains a solid state lubrication agent.

4. The oil-impregnated bearing of claim 3 further having two caps mounting to two sides of the bearing for preventing the solid state lubrication agent from spilling out.

5. The oil-impregnated bearing of claim 1, wherein the extended trough is formed in even number and symmetrically located about the center of the center opening.

6. The oil-impregnated bearing of claim 5, wherein the extended trough is formed and configured in a polygon and symmetrically located about the center of the center opening.

7. The oil-impregnated bearing of claim 1, wherein the contact area between the shaft and the inner wall surface of the center opening resulting from the extended trough is preferably about 65% of the inner wall surface of the center opening.
